(19) United States
(12) Patent Application Publication
(10) Pub. No.: US 2025/0308014 A1
(43) Pub. Date: Oct. 2, 2025

(54) SYSTEM FOR PACKAGING SECONDARY BATTERY AND METHOD FOR DETECTING FAULT THEREOF

(71) Applicant: SK ON CO., LTD., Seoul (KR)

(72) Inventors: Ju Hee PARK, Daejeon (KR); Do Young KIM, Daejeon (KR)

(21) Appl. No.: 19/010,189

(22) Filed: Jan. 6, 2025

(30) Foreign Application Priority Data
Mar. 29, 2024 (KR) 10-2024-0043478
Aug. 22, 2024 (KR) 10-2024-0112897

(51) Int. Cl. G06T 7/00; G06T 7/73; H01M 10/04

(52) U.S. Cl. CPC G06T 7/001; G06T 7/0008; G06T 7/74; H01M 10/04

(57) ABSTRACT

The present disclosure relates to a system for packaging a secondary battery and a method for detecting a fault thereof. The method according to an embodiment of the present disclosure may include: through a photographing device, photographing a part of the system so as to include an identification mark formed at a designated position of the system to acquire an inspection image; detecting the identification mark from the inspection image; calculating a position of the identification mark based on a first reference point related to a field of view of the photographing device; and determining a state of the photographing device, based on the calculated position of the identification mark and previously stored first reference information.

### CROSS-REFERENCE TO RELATED APPLICATION

The present application claims priority to and the benefit of Korean Patent Application No. 10-2024-0043478, filed on Mar. 29, 2024, and Korean Patent Application No. 10-2024-0112897, filed on Aug. 22, 2024, as filed with the Korean Intellectual Property Office, the entire disclosures of which are incorporated by reference herein.

### BACKGROUND OF THE INVENTION

### 1. Field of the Invention

The present disclosure relates to a system for packaging a secondary battery and a method for detecting a fault thereof.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a tablet personal computer (PC), a laptop PC, etc. as a power source thereof. Recently, a battery pack including the secondary battery has also been developed as a power source of an eco-friendly automobile such as an electric vehicle.

Meanwhile, the secondary battery is generally manufactured through an electrode process, an assembly process, an activation process, and an inspection process. The assembly process may include, for example, a notching process, a stacking process, and a packaging process. The packaging process is a process of wrapping a battery cell (e.g., a jelly roll, a stacked cell, etc.) into a can of a designated type (e.g., a cylinder, a square, a pouch, etc.), and injecting an electrolyte into the can.

During the packaging process, a tray in which the battery cell is accommodated (or placed) should be accurately positioned at the designated position. However, the tray may not be accurately positioned at the designated position due to various reasons. For example, the tray may not be accurately positioned at the designated position due to an injection tolerance, and may be positioned out of alignment. Accordingly, the secondary battery packaging system disposes a photographing device (e.g., a camera) above the designated position, and monitors a state (e.g., an alignment state) of the tray through the photographing device.

However, the current packaging system only detects the state of the tray (e.g., the alignment state), and does not consider the state of the photographing device. Thereby, the current packaging system may have a problem that, if a fault state (e.g., misalignment) of the photographing device occurs, the state of the tray is misrecognized. Accordingly, a method for detecting (or monitoring) the state of the photographing device included in the packaging system is required.

### SUMMARY OF THE INVENTION

According to an aspect of the present disclosure, it is an object to provide a system for packaging a secondary battery and a method for detecting a fault thereof, which are capable of improving inspection accuracy of the packaging system.

According to another aspect of the present disclosure, it is an object to provide a system for packaging a secondary battery and a method for detecting a fault thereof, which are capable of improving precision and/or stability of packaging of the secondary battery.

To achieve the above objects, according to an aspect of the present invention, there is provided a method for detecting a fault in a system for packaging a secondary battery, which includes: through a photographing device, photographing a part of the system so as to include an identification mark formed at a designated position of the system to acquire an inspection image; detecting the identification mark from the inspection image; calculating a position of the identification mark based on a first reference point related to a field of view of the photographing device; and determining a state of the photographing device, based on the calculated position of the identification mark and previously stored first reference information.

According to an embodiment, the step of determining a state of the photographing device may include: calculating a distance between the identification mark and the first reference point; if the difference between the calculated distance and the previously stored first reference distance is within a designated first reference value, determining that the photographing device is in a normal state; and if the difference between the calculated distance and the first reference distance exceeds the first reference value, determining that the photographing device is in an abnormal state, and providing a first alarm to notify the abnormal state of the photographing device.

According to an embodiment, the method may further include, if the difference exceeds the first reference value, correcting the photographing device to the normal state through a driving device configured to control a position of the photographing device.

According to an embodiment, the step of acquiring an inspection image may include moving a tray in which at least one battery cell to be packaged is accommodated to a designated position, and acquiring the inspection image so as to include the tray and the identification mark.

According to an embodiment, the method may further include identifying a tray area from the inspection image; and determining a state of the tray, based on a second reference point related to the tray area and the position of the identification mark.

According to an embodiment, the step of determining a state of the tray may include: calculating a distance between the second reference point and the identification mark; if the difference between the calculated distance and the previously stored second reference distance is within a designated second reference value, determining that the tray is in a normal state; and if the difference between the calculated distance and the second reference distance exceeds the second reference value, determining that the tray is in an abnormal state, and providing a second alarm to notify the abnormal state of the tray.

According to an embodiment, the method may further include, if the difference exceeds the second reference value, realigning the tray.

According to an embodiment, the step of realigning the tray may include: generating a correction value for realigning the tray based on the difference; and realigning the tray to a prescribed position based on the generated correction value.

According to an embodiment, the step of detecting the identification mark may include detecting the identification mark from the inspection image through pattern matching.

According to another aspect of the present invention, there is provided a system for packaging a secondary battery, including: a photographing device configured to photograph a subject; a transfer device configured to transfer at least one battery cell to be packaged; and a control device configured to control the photographing device to acquire an inspection image including an identification mark formed on one side of the transfer device, detect the identification mark from the inspection image, calculate a position of the identification mark based on a first reference point related to a field of view of the photographing device, and determine a state of the photographing device, based on the calculated position of the identification mark and previously stored first reference information.

According to an embodiment, the control device may calculate a distance between the identification mark and the first reference point, if the difference between the calculated distance and the previously stored first reference distance is within a designated first reference value, determine that the photographing device is in a normal state; and if the difference between the calculated distance and the first reference distance exceeds the first reference value, determine that the photographing device is in an abnormal state, and provide a first alarm to notify the abnormal state of the photographing device.

According to an embodiment, the system may further include at least one driving device to control a position of the photographing device, wherein if the difference exceeds the first reference value, the control device corrects the photographing device to the normal state through the at least one driving device.

According to an embodiment, the transfer device may include: a tray in which at least one battery cell to be packaged is accommodated; a moving guide configured to transfer the tray; and a body to which the moving guide is movably coupled.

According to an embodiment, the control device may control the transfer device to move the tray to a designated position, and control the photographing device to acquire an inspection image including the tray and the identification mark.

According to an embodiment, the control device may identify a tray area from the inspection image including the tray and the identification mark, and determine a state of the tray, based on a second reference point related to the tray area and the position of the identification mark.

According to an embodiment, the control device may calculate a distance between the second reference point and the identification mark, if the difference between the calculated distance and the previously stored second reference distance is within a designated second reference value, determine that the tray is in a normal state, and if the difference between the calculated distance and the second reference distance exceeds the second reference value, determine that the tray is in an abnormal state, and provide a second alarm to notify the abnormal state of the tray.

According to an embodiment, if the difference exceeds the second reference value, the control device may perform realignment of the tray.

According to an embodiment, the control device may generate a correction value for realigning the tray based on the difference, and realign the tray to a prescribed position based on the generated correction value.

According to an embodiment, the control device may detect the identification mark from the inspection image through pattern matching.

According to an embodiment, the identification mark may include a fiducial mark or a calibration glass.

According to an embodiment, the present disclosure may improve (or enhance) the accuracy of inspection (e.g., fault state detection) of the packaging system. For example, the present disclosure may detect a fault state (e.g., misalignment) of a photographing device that photographs battery cells and a tray in which the battery cells are accommodated. Thereby, the present disclosure may prevent a problem that the state of the tray is misrecognized due to the fault state of the photographing device. In other words, the present disclosure may improve the accuracy of the fault state detection of the packaging system.

In addition, the present disclosure may improve the precision and/or stability of packaging of the secondary battery. For example, the present disclosure may realign the tray to an accurate position before performing packaging. Thereby, the present disclosure may improve the precision and/or stability of packaging.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a system for packaging a secondary battery according to an embodiment of the present disclosure;

FIG. 2A is an exemplary diagram illustrating an inspection image acquired when a photographing device according to an embodiment of the present disclosure is in a normal state;

FIG. 2B is an exemplary diagram illustrating an inspection image acquired when the photographing device according to an embodiment of the present disclosure is in an abnormal state;

FIG. 2C is an exemplary diagram illustrating an inspection image acquired when a tray according to an embodiment of the present disclosure is in a normal state;

FIG. 2D is an exemplary diagram illustrating an inspection image acquired when the tray according to an embodiment of the present disclosure is in an abnormal state;

FIG. 3 is a flowchart for describing procedures of a fault detection method of a packaging system according to an embodiment of the present disclosure;

FIG. 4 is a flowchart for describing procedures of a method for determining a state of a photographing device according to an embodiment of the present disclosure; and

FIG. 5 is a flowchart for describing procedures of a method for determining a state of a tray according to an embodiment of the present disclosure.

### DETAILED DESCRIPTION OF THE INVENTION

Hereinafter, a present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

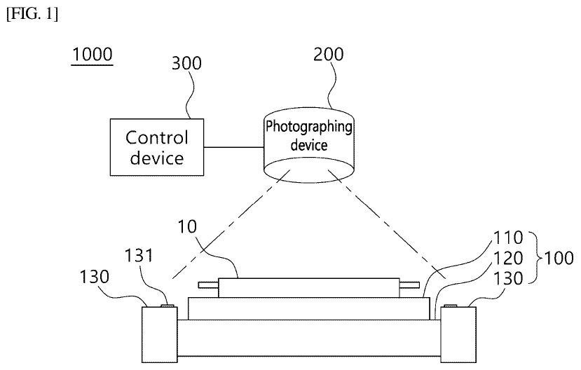

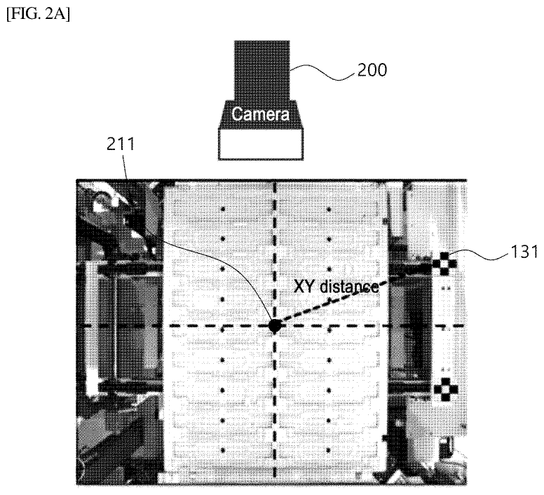

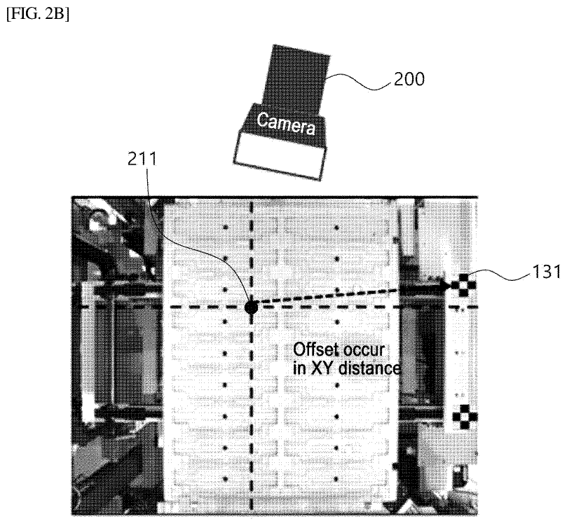

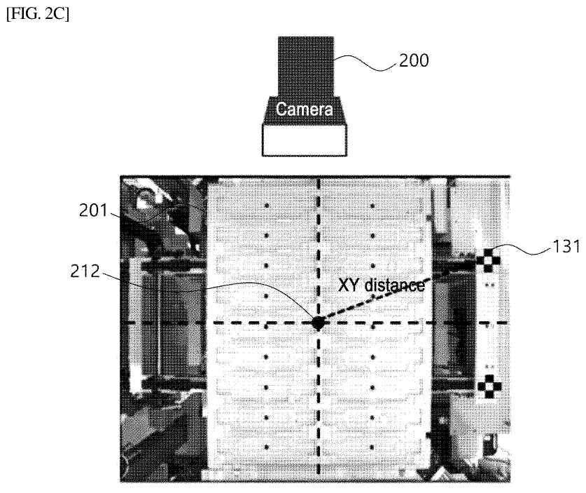

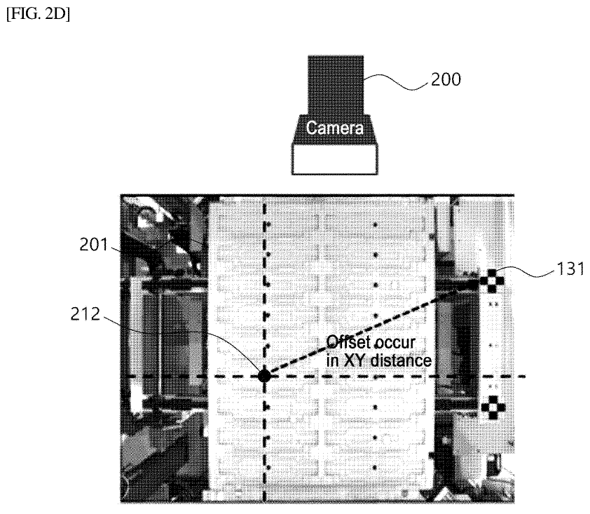

FIG. 1 is a view illustrating a system for packaging a secondary battery according to an embodiment of the present disclosure, FIG. 2A is an exemplary diagram illustrating an inspection image acquired when a photographing device according to an embodiment of the present disclosure is in a normal state, FIG. 2B is an exemplary diagram illustrating an inspection image acquired when the photographing device according to an embodiment of the present disclosure is in an abnormal state, FIG. 2C is an exemplary diagram illustrating an inspection image acquired when a tray according to an embodiment of the present disclosure is in a normal state, and FIG. 2D is an exemplary diagram illustrating an inspection image acquired when the tray according to an embodiment of the present disclosure is in an abnormal state.

Referring to FIGS. 1 to 2D, a system 1000 for packaging a secondary battery according to an embodiment of the present disclosure may include a transfer device 100, a photographing device 200, and a control device 300.

The transfer device 100 may include a tray 110 in which at least one battery cell 10 is accommodated (or placed), a moving guide (e.g., a linear motion (LM) guide) 120 for moving the tray 110, and a body 130 to which the moving guide 120 is movably coupled (e.g., to enable a linear movement). According to an embodiment, the transfer device 100 may transfer the battery cell 10 to be packaged to a designated position. For example, the transfer device 100 may transfer the tray 110 in which at least one battery cell 10 is accommodated (or empty) to the designated position (e.g., a lower side of the photographing device 200) using the moving guide 120. The body 130 may include at least one identification mark 131 having a designated pattern on one side (e.g., an upper surface) thereof. This is only an example, and the identification mark 131 may be formed at various positions of the system 1000. Meanwhile, the identification mark 131 may be formed on one side of the system 1000 (e.g., the upper surface of the body 130) through various methods (e.g., printing, attaching, engraving, etc.). In other words, the identification mark 131 may be positioned on an outside of the tray 110. The identification mark 131 may include a fiducial mark, a calibration glass, but it is not limited thereto.

The photographing device 200 may photograph a subject. In one embodiment, the photographing device 200 may photograph at least a part of the system 1000 so as to include the tray 110 and the identification mark 131. The photographing device 200 may be positioned above the designated position (e.g., a position where the tray 110 is transferred for packaging of the battery cells). For example, the photographing device 200 may be installed on the ceiling of a place where the system 1000 is installed. As another example, the photographing device 200 may be installed above the designated position using a separate structure (e.g., a structure extending from the body 130).

According to some embodiments, the photographing device 200 may include at least one driving device (not shown) that can move the photographing device 200 in at least one direction. This is intended to correct a position of the photographing device 200 when a fault state (e.g., misalignment in at least one direction) of the photographing device 200 is detected (or determined).

The control device 300 may control the photographing device 200 and the transfer device 100. According to an embodiment, when the photographing device 200 and the tray 110 are in a normal state (e.g., a state without misalignment), the control device 300 may acquire a reference inspection image so as to include the tray 110 and the identification mark 131. The control device 300 may measure a distance between a first reference point 211 and the identification mark 131 (or a position of the identification mark 131 with the first reference point 211 as an origin (hereinafter, referred to as a first relative position)) from the reference inspection image, and store the measured distance (or the first relative position) as first reference information (e.g., a first reference distance or a first reference relative position) for determining a state of the photographing device 200. The first reference point 211 may be a point where a horizontal reference line and a vertical reference line on a field of view (FOV) of the photographing device 200 intersect. In addition, the control device 300 may measure a distance between a second reference point 212 and the identification mark 131 (or a position of the identification mark 131 with the second reference point 212 as an origin (hereinafter, referred to as a second relative position) from the reference detection image, and store the measured distance (or the second relative position) as second reference information (e.g., the second reference distance or the second reference relative position) for determining a state of the tray 110. The second reference point 212 may be a point (e.g., a center point of the tray area) where the horizontal reference line and a vertical reference line on the tray 110 intersect. The second reference point 212 may be the same as or different from the first reference point 211.

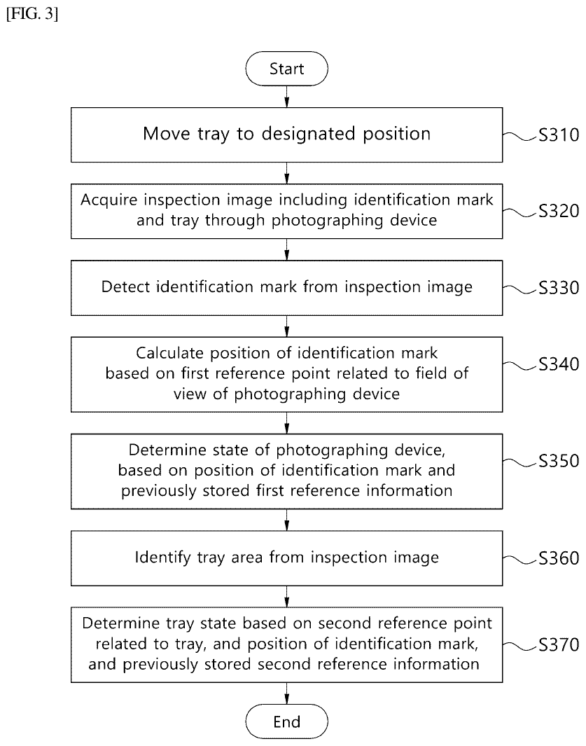

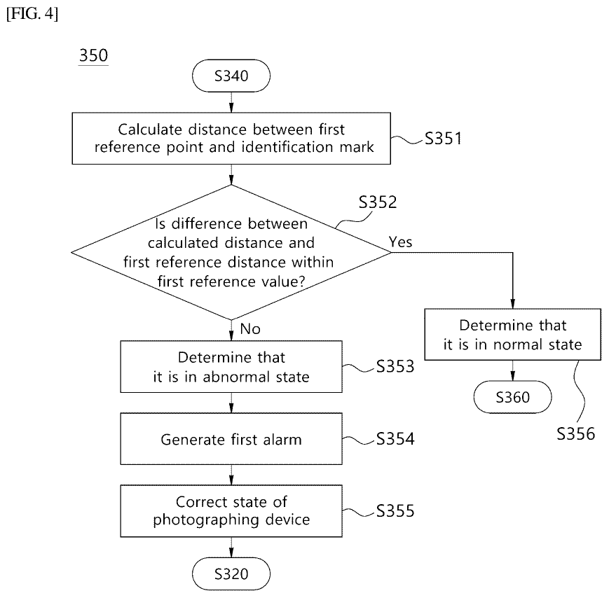

The control device 300 may capture an inspection image by photographing the identification mark 131 and/or the tray 110 through the photographing device 200, and determine a state of the photographing device 200 and/or the tray 110 (e.g., whether they are aligned) based on the acquired inspection image. For example, the control device 300 may detect the identification mark 131 from the inspection image, and determine the state of the photographing device 200 based on a position of the detected identification mark 131. Specifically, the control device 300 may compare the distance (or the relative position) between the first reference point 211 and the identification mark 131 with the first reference information to determine the state of the photographing device 200. For example, as shown in FIG. 2A, if the distance between the first reference point 211 and the identification mark 131 is similar to the first reference distance (e.g., if a difference between the distance from the first reference point 211 to the identification mark 131 and the first reference distance is within a first reference value), the control device 300 may be determined that the photographing device 200 is in a normal state. On the other hand, as shown in FIG. 2B, if the distance between the first reference point 211 and the identification mark 131 is not similar to the first reference information (e.g., if the difference between the distance from the first reference point 211 to the identification mark 131 and the first reference distance exceeds the first reference value), the control device 300 may determine that the photographing device 200 is in an abnormal state, which will be described in detail below with reference to FIGS. 3 and 4.

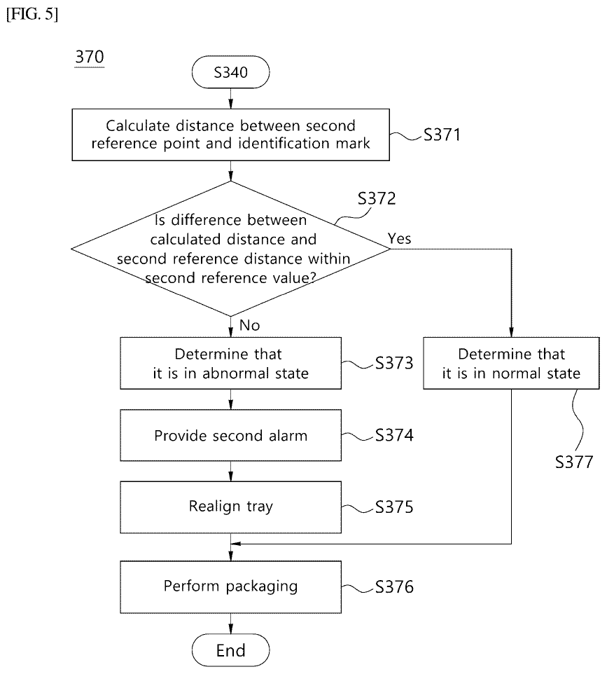

In addition, the control device 300 may identify a tray area 201 from the inspection image, and determine the state of the tray 110 (e.g., whether it is misaligned or aligned) based on the identified tray area 201 and the identification mark 131. For example, the control device 300 may identify the tray area 201 from the inspection image using an edge detection technique, recognize the second reference point 212 from the identified tray area 201, calculate a distance (or a relative position) between the second reference point 212 and the identification mark 131 (e.g., a center point of the identification mark 131), and determine the state of the tray 110 by comparing the calculated distance with the second reference information. For example, as shown in FIG. 2C, if the distance between the second reference point 212 of the tray area 201 and the identification mark 131 is similar to the second reference information (e.g., if a difference between the distance from the second reference point 212 to the identification mark 131 and the second reference distance is within a designated second reference value), the control device 300 may determine that the tray 110 is in a normal state. On the other hand, as shown in FIG. 2D, if the distance between the second reference point 212 and the identification mark 131 is not similar to the second reference information (e.g., if the difference between the distance from the second reference point 212 to the identification mark 131 and the second reference distance exceeds the designated second reference value), the control device 300 may determine that the tray 110 is in an abnormal state, which will be described in detail below with reference to FIGS. 3 and 5.

FIG. 3 is a flowchart for describing procedures of a fault detection method of a packaging system according to an embodiment of the present disclosure.

Referring to FIG. 3, the fault detection method of a packaging system according to an embodiment of the present disclosure may include a step S310 of moving a tray to a designated position. For example, the transfer device 100 of the system may move the tray 110, in which at least one battery cell 10 to be packaged is accommodated, to the designated position. The control device 300 may control the transfer device 100 to move the tray to the designated position. The designated position may be the lower side of the photographing device 200.

The fault detection method may include a step S320 of acquiring an inspection image including the identification mark and the tray through a photographing device. For example, the control device 300 of the system may control the photographing device 200 to photograph a partial area of the packaging system including the identification mark 131 and the tray 110, thereby acquiring an inspection image. The identification mark 131 may have a designated pattern, and one or more marks may be formed on the outside of the tray 110 (e.g., the upper surface of the body 130).

The fault detection method may include a step S330 of detecting an identification mark from the inspection image. For example, the control device 300 may detect the identification mark from the inspection image through pattern matching.

The fault detection method may include a step S340 of calculating a position of the identification mark based on the first reference point related to the field of view of the photographing device. For example, the control device 300 may recognize the first reference point 211 and the center point of the identification mark 131, and calculate the position of the identification mark 131 (e.g., a center of the identification mark) based on the first reference point 211. The first reference point 211 may be a center point of the field of view (FOV) of the photographing device 200 in a normal state.

The fault detection method may include a step S350 of determining a state of the photographing device (e.g., whether it is misaligned), based on the position of the identification mark and previously stored first reference information. For example, the control device 300 may determine the state of the photographing device 200, based on the position of the identification mark and the previously stored first reference information, which will be described in detail below with reference to FIG. 4.

The fault detection method may include a step S360 of identifying a tray area from the inspection image. For example, if it is determined that the photographing device 200 is in a normal state (e.g., in a state where there is no misalignment), the control device 300 may identify the tray area from the inspection image. Specifically, the control device 300 may identify the tray area from the inspection image through edge detection.

The fault detection method may include a step S370 of determining a tray state based on the second reference point related to the tray, a position of the identification mark, and/or previously stored second reference information. For example, the control device 300 may calculate a distance between the second reference point and the identification mark, and determine the state of the tray 110 (e.g., whether it is misaligned or aligned) based on the calculated distance, which will be described in detail below with reference to FIG. 5.

Meanwhile, when determining only the state of the photographing device 200, the step S310 may be omitted. As another example, the step S310 may be performed after it is determined that the photographing device 200 is in the normal state (e.g., after step S355 of FIG. 4).

FIG. 4 is a flowchart for describing procedures of a method for determining a state of a photographing device according to an embodiment of the present disclosure.

Referring to FIG. 4, the method for determining a state of a photographing device according to an embodiment of the present disclosure may include a step S351 of calculating a distance between the identification mark and the first reference point. For example, the control device 300 may calculate a distance between the identification mark (e.g., the center point of the identification mark) and the first reference point.

The method may include a step S352 of checking whether a difference between the calculated distance and the previously stored first reference distance is within a designated first reference value. For example, the control device 300 may calculate a difference between the calculated distance and the first reference distance, and check whether the calculated difference is within the first reference value.

As a result of the check in the step S352, if the difference exceeds the first reference value, the method may proceed to a step S353 of determining that it is in an abnormal state. For example, if the difference exceeds the first reference value, the control device 300 may determine that the photographing device 200 is in an abnormal state (e.g., a state where the misalignment in at least one direction has occurred).

The method may include a step S354 of generating a first alarm. For example, the control device 300 may provide a first alarm to notify the abnormal state of the photographing device 200 (and/or requests correction of the photographing device 200) in a designated manner (e.g., an auditory notification, a visual notification, and/or a tactile notification).

The method may include a step S355 of correcting the state of the photographing device. For example, the control device 300 may move the photographing device 200 in at least one direction to correct it to a normal state. To this end, the photographing device 200 may include at least one driving device (not shown) capable of moving the photographing device 200 in the at least one direction. After correcting the state of the photographing device 200, the method may return to the step S320. In other words, after correcting the state of the photographing device 200, the method may determine the state of the photographing device 200 again, and determine whether the photographing device 200 has been appropriately corrected.

On the other hand, as a result of the check in the step S352, if the difference is within the first reference value, the method may proceed to a step S356 of determining that it is in a normal state. For example, if the difference is within the first reference value, the control device 300 may determine that the photographing device 200 is in a normal state (e.g., a state where the misalignment is within the designated range). If the photographing device 200 is determined to be in the normal state, the method may proceed to the step S360.

Meanwhile, if the photographing device 200 does not include at least one driving device, the step S355 may be omitted. In other words, the method may be ended at the step S354. In addition, the state of the photographing device 200 may be manually corrected by a manager.

FIG. 5 is a flowchart for describing procedures of a method for determining a state of the tray according to an embodiment of the present disclosure.

Referring to FIG. 5, the method for determining a state of the tray according to an embodiment of the present disclosure may include a step S371 of calculating a distance between the second reference point and the identification mark. For example, the control device 300 may calculate a distance between the second reference point related to the tray and the identification mark (e.g., the center point of the identification mark).

The method may include a step S372 of checking whether a difference between the calculated distance and the previously stored second reference distance is within a designated second reference value. For example, the control device 300 may calculate a difference between the calculated distance and the second reference distance, and check whether the calculated difference is within the second reference value.

As a result of the check in the step S372, if the difference exceeds the second reference value, the method may proceed to a step S373 of determining that it is in an abnormal state. For example, if the difference exceeds the second reference value, the control device 300 may determine that the tray is in an abnormal state (e.g., a state where the misalignment in at least one direction has occurred).

The method may include a step S374 of providing a second alarm. For example, the control device 300 may provide a second alarm to notify the abnormal state of the tray 110 in the designated manner (e.g., the auditory notification, the visual notification, and/or the tactile notification).

The method may include a step S375 of realigning the tray. For example, the control device 300 may calculate a correction value for realigning the tray 110 based on the difference, and realign the tray 110 to the prescribed position based on the calculated correction value.

The method may include a step S376 of performing packaging. For example, the control device 300 may control a packaging device (not shown) to wrap the battery cell with a can, and inject an electrolyte into the can.

On the other hand, as a result of the check in the step S372, if the difference is within the second reference value, the method may proceed to a step S376 of determining that it is in a normal state. For example, if the difference is within the second reference value, the control device 300 may determine that the tray 110 is in the normal state (e.g., the state where the misalignment is within the designated range). Thereafter, the method may proceed to the step S376.

On the other hand, although not shown in FIG. 5, the method may further include a step of determining a state of the tray 110 again after performing the step S375. For example, after the tray 110 is realigned, the control device 300 may photograph the subject to acquire an inspection image, and determine whether the tray 110 is appropriately realigned to the prescribed position based on the recaptured inspection image.

The contents described above are merely an example to which the principles of the present disclosure are applied, and other configurations may be further included in the present disclosure without departing from the scope of the present invention. For example, at least some of the above-described various embodiments of the present disclosure may be combined.

What is claimed is:

1. A method for detecting a fault in a system for packaging a secondary battery, the method comprising:
through a photographing device, photographing a part of the system so as to include an identification mark formed at a designated position of the system to acquire an inspection image;
detecting the identification mark from the inspection image;
calculating a position of the identification mark based on a first reference point related to a field of view of the photographing device; and
determining a state of the photographing device, based on the calculated position of the identification mark and previously stored first reference information.

2. The method according to claim 1, wherein the step of determining a state of the photographing device comprises:
calculating a distance between the identification mark and the first reference point;
if the difference between the calculated distance and the previously stored first reference distance is within a designated first reference value, determining that the photographing device is in a normal state; and
if the difference between the calculated distance and the first reference distance exceeds the first reference value, determining that the photographing device is in an abnormal state, and providing a first alarm to notify the abnormal state of the photographing device.

3. The method according to claim 2, further comprising, if the difference exceeds the first reference value, correcting the photographing device to the normal state through a driving device configured to control a position of the photographing device.

4. The method according to claim 1, wherein the step of acquiring an inspection image comprises moving a tray in which at least one battery cell to be packaged is accommodated to a designated position, and acquiring the inspection image so as to include the tray and the identification mark.

5. The method according to claim 4, further comprising identifying a tray area from the inspection image; and
determining a state of the tray, based on a second reference point related to the tray area and the position of the identification mark.

6. The method according to claim 5, wherein the step of determining a state of the tray comprises:
calculating a distance between the second reference point and the identification mark;
if the difference between the calculated distance and the previously stored second reference distance is within a designated second reference value, determining that the tray is in a normal state; and
if the difference between the calculated distance and the second reference distance exceeds the second reference value, determining that the tray is in an abnormal state, and providing a second alarm to notify the abnormal state of the tray.

7. The method according to claim 6, further comprising, if the difference exceeds the second reference value, realigning the tray.

8. The method according to claim 7, wherein the step of realigning the tray comprises:
generating a correction value for realigning the tray based on the difference; and
realigning the tray to a prescribed position based on the generated correction value.

9. The method according to claim 1, wherein the step of detecting the identification mark comprises detecting the identification mark from the inspection image through pattern matching.

10. A system for packaging a secondary battery, comprising:
a photographing device configured to photograph a subject;
a transfer device configured to transfer at least one battery cell to be packaged; and
a control device configured to control the photographing device to acquire an inspection image including an identification mark formed on one side of the transfer device, detect the identification mark from the inspection image, calculate a position of the identification mark based on a first reference point related to a field of view of the photographing device, and determine a state of the photographing device, based on the calculated position of the identification mark and previously stored first reference information.

11. The system according to claim 10, wherein the control device
calculates a distance between the identification mark and the first reference point,
if the difference between the calculated distance and the previously stored first reference distance is within a designated first reference value, determines that the photographing device is in a normal state; and
if the difference between the calculated distance and the first reference distance exceeds the first reference value, determines that the photographing device is in an abnormal state, and provides a first alarm to notify the abnormal state of the photographing device.

12. The system according to claim 11, further comprising at least one driving device to control a position of the photographing device,
wherein if the difference exceeds the first reference value, the control device corrects the photographing device to the normal state through the at least one driving device.

13. The system according to claim 10, wherein the transfer device comprises:
a tray in which at least one battery cell to be packaged is accommodated;
a moving guide configured to transfer the tray; and
a body to which the moving guide is movably coupled.

14. The system according to claim 13, wherein the control device controls the transfer device to move the tray to a designated position, and controls the photographing device to acquire an inspection image including the tray and the identification mark.

15. The system according to claim 14, wherein the control device
identifies a tray area from the inspection image including the tray and the identification mark, and
determines a state of the tray, based on a second reference point related to the tray area and the position of the identification mark.

16. The system according to claim 15, wherein the control device
calculates a distance between the second reference point and the identification mark,
if the difference between the calculated distance and the previously stored second reference distance is within a designated second reference value, determines that the tray is in a normal state, and
if the difference between the calculated distance and the second reference distance exceeds the second reference value, determines that the tray is in an abnormal state, and provides a second alarm to notify the abnormal state of the tray.

17. The system according to claim 16, wherein, if the difference exceeds the second reference value, the control device performs realignment of the tray.

18. The system according to claim 17, wherein the control device
generates a correction value for realigning the tray based on the difference, and
realigns the tray to a prescribed position based on the generated correction value.

19. The system according to claim 10, wherein the control device detects the identification mark from the inspection image through pattern matching.

20. The system according to claim 10, wherein the identification mark comprises a fiducial mark or a calibration glass.
